(19) United States
(12) Patent Application Publication
(10) Pub. No.: US 2005/0190006 A1
(43) Pub. Date: Sep. 1, 2005

(54) Flat flexible circuitry

(76) Inventors: Atsuhito Noda, Fujisawa (JP); Teruhito Suzuki, Yamato-shi (JP); Toshihiro Niitsu, Tokyo (JP)

Correspondence Address: MOLEX INCORPORATED, 2222 WELLINGTON COURT, LISLE, IL, 60532, US

(21) Appl. No.: 11/069,100

(22) Filed: Feb. 28, 2005

(30) Foreign Application Priority Data
Feb. 27, 2004 (JP) 2004-53558

(51) Int. Cl. H01P 3/08

(52) U.S. Cl. 333/1; 333/238

(57) ABSTRACT

An improved signal transmission line whose degree of freedom in designing its signal line pattern and line width and in adjusting its characteristic impedance is significantly increased. The transmission line. The signal transmission line includes an insulating substrate whose one surface has at least one signal line longitudinally extending from one to the other end of the insulating substrate; and two net-like conductive layers laid on the opposite surfaces of the insulating substrate, the spaces for each of the net-like conductive layers being formed at random.

### BACKGROUND OF THE INVENTION

The present invention relates generally to a flat signal transmission board taking the form of flat flexible circuitry whose signal lines are shielded, and connectors for making a connection between the same and an associated connector.

One example of conventional signal transmission means is a flat, flexible circuitry (“FFC”) having signal lines disposed on one surface thereof, and a metal sheet on the other surface for shielding the signal lines. In order to improve the flexibility of the FFC, a metal net is used in place of the metal sheet.

In order to permit adjusting of the impedance of the signal lines at high frequencies, the use of a metal mesh whose spaces are irregular in shape and size is shown in Japanese Patent Laid-Open Publication No. 10-112224. According to Japanese Patent No. 3397707, the high-frequency impedance of a length of FFC can be adjusted if its signal lines are sandwiched between upper and lower shield plates, and the size of a series of apertures made along each signal line depends upon the length or cross section of the signal line. Alternatively, the signal lines may be sandwiched between upper and lower shield grids, which are staggered in the direction in which the signal lines extend, as shown in Japanese Patent Laid-Open Publication No. 8-506696.

The FFC structures whose shielding is in the form of nets which have irregular spaces provides an advantage of increasing the degree of freedom in designing signal lines on the flexible insulating substrate of the FFC. The characteristic impedance, however, increases with the increase of the aperture size of the net. The signal line width may be increased with the increase of the aperture sizes, such as in a coarse net permissible for a given large characteristic impedance, and accordingly the electromagnetic shielding effect will be lowered. Also disadvantageously, the adjustment to the characteristic impedance is limited to only one net layer, and accordingly the degree of freedom in adjustment of the FFC overall is limited.

The present invention is directed to an FFC structure that overcomes the aforementioned disadvantages.

### SUMMARY OF THE INVENTION

It is therefore a general object of the present invention to provide a signal transmission board in the form of FFC which has an increased degree of freedom for designing signal lines with respect of their pattern and line width, and the characteristic impedance of which is easier to adjust.

Another object of the present invention is to provide a connector for connecting such an FFC transmission line to a connector with high reliability.

To attain these and other objects of the present invention, a signal transmission board constructed in accordance with the principles of the present invention includes an FFC structure having an insulating substrate with two surfaces. One of the two surfaces has at least one signal line extending longitudinally from one to the other end of the insulating substrate, and two net-like conductor layers are overlaid on the other (and opposite) surface of the insulating substrate.

The net-like conductor layers have a plurality of apertures or openings that are formed at random in the net. The spaces for each of the net-like conductor layers may be different in size or shape, or the crossing areas for each of the net-like conductor layers may be irregular.

The one surface of the insulating substrate has signal contact pads disposed thereon that are connected to the ends of the signal lines, and it also includes grounding contact pads that are connected to the opposite ends of the net-like conductor layer. The signal contact pads and the grounding contact pads are preferably arranged in parallel on the one surface; while the other surface of the insulating substrate has dummy pads and grounding contact pads also preferably arranged in parallel, so that the dummy pads confront the overlying signal contact pads via the intervening insulating substrate. The ground contact pads are connected to the net-like conductor layer on the other surface, and they confront the overlying grounding contact pads via the intervening insulating substrate.

Connectors used with this structure will typically include bifurcated contact arms as part of their terminals. These contact arms will pinch the signal contact pads and the dummy pads on the opposite surfaces of one end of the insulating substrate, and similarly, the ground contact pads on the opposite surfaces of the one end of the insulating substrate. This pinching allows the bifurcated contact arms to be applied to the contact pads at preselected pressures.

Another connect may utilize terminals that have single contact beams. In this instance, the FFC will include an insulative substrate having at least one signal line extending between opposite ends of one surface of the substrate. It will also include net-like conductive layers disposed on the opposite surface of the substrate. On the one surface of the substrate, the signal contact pads are connected to the opposing ends of the signal line, and the ground contact pads are connected to the opposing ends of the net-like conductive layer. The signal and the ground contact pads are arranged in parallel on the substrate one surface; while the other surface of the substrate has dummy pads and ground contact pads arranged in parallel, the dummy pads confronting the overlying signal contact pads on the opposite surface of the substrate. The ground contact pads are connected to the net-like conductive layer on the substrate other surface, and they confront the overlying ground contact pads, also on an opposite surface of the substrates.

In this instance, the terminal single contact beams of the electric connector are applied by the contacts to the signal contact pads and the ground contact pads on the one surface of one end of the substrate at a preselected pressure, and the ground contact pads on the opposite surfaces of the substrate are electrically connected through the substrate.

The two-layer lamination of irregular net-like conductive sheets, or layers effectively increases the degree of freedom of designing the signal line with respect of line pattern and line width, changing its space shape, space size and crossing areas. The degree of freedom of tuning the characteristic impedance of the signal line is also increased. The sandwiching shielding structure improves the electromagnetic shielding effect, compared with a FFC length that has a single electromagnetic shielding layer.

In signal transmission lines of the present invention, the insulative substrate has, on either end, its signal and ground contact pads arranged in parallel on one surface and the dummy and ground pads arranged in parallel on the other surface. The pads on one surface confront those on the other surface on opposite sides of the substrate, and the contact portions of the connector terminal contact and abut the contact pads of the FFC. This arrangement effectively assures that the terminal contacts may be applied to the contact pads at same pressure. Thus, a reliable connection can be made.

### BRIEF DESCRIPTION OF THE DRAWINGS

The present invention will now be described in detail with reference to the accompanying drawings, in which:

FIG. 1A is an exploded perspective view of one embodiment of an improved signal transmission line having the form of a flat, flexible cable that is constructed in accordance with the principles of the present invention;

FIG. 1B is an enlarged detail view of a portion of one of the net-like conductive layers of the flat, flexible cable of FIG. 1A;

FIG. 1C is an enlarged detail view of a selected part of the other net-like conduciver layer of the flat, flexible cable of FIG. 1A;

FIG. 2 is an enlarged perspective view of one end of the flat, flexible cable;

FIG. 3 is a cross section of the flat, flexible cable taken along line A-A of FIG. 2;

FIG. 4 is a cross section of the flat, flexible cable taken at the middle of the cable;

FIG. 5 is a longitudinal section of a connector use to connect the signla transmission line of FIG. 1A to electrical circuits;

FIG. 6 is a longitudinal section of another embodiment of a signal transmission line connector of the present invention;

FIG. 7 shows, in section, a selected plated through hole electrically connecting the upper and lower grounding contact pads at one end of the flat, flexible cable; and,

FIG. 8 shows, in section, a selected conductive bump that electrically interconnects the upper and lower grounding contact pads at one end of the flat, flexible cable

### DESCRIPTION OF THE PREFERRED EMBODIMENT

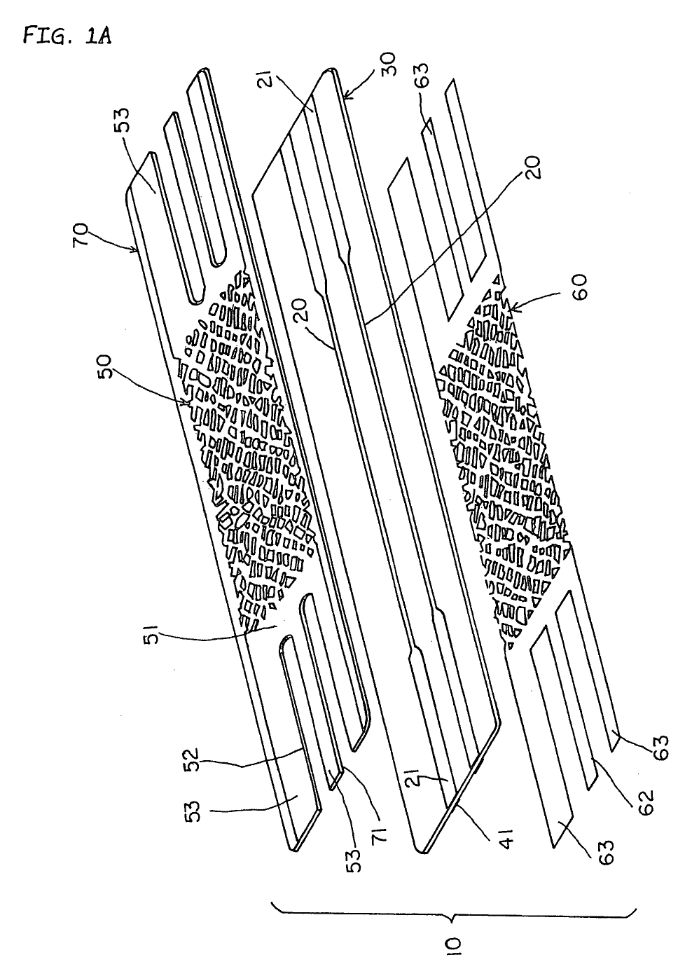

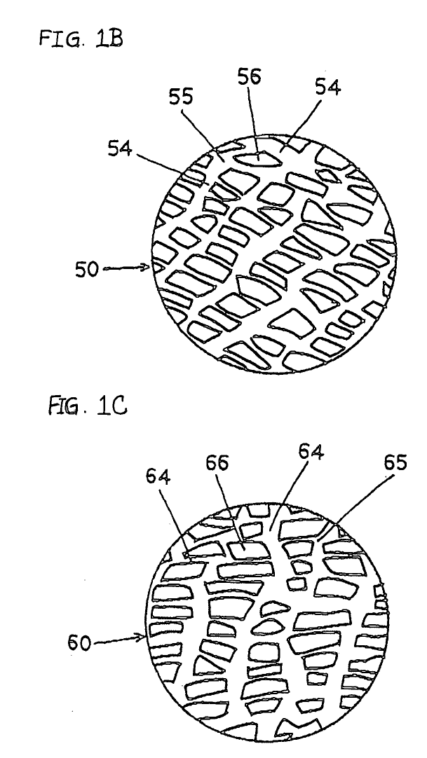

FIG. 1A shows a signal transmission line in the form of an extent of flat, flexible cable (“FFC”) 10 according to one embodiment of the present invention in the state of being exploded. As shown, on one surface of a flexible insulative substrate 30 extend two signal lines 20 from one to the other end, which signal lines 20 end with signal contact pads 21 at each end of the substrate 30. Dummy contact pads 41 are arranged on the other surface of the substrate 30 and are aligned with (on in onfronting relationship with) the overlying signal contact pads 21 on the one surface of the substrate 30. Two grounding contact pads 63 are arranged on each end of the substrate 30 and are arranged in parallel widthwise along the substrate. The dummy pad 41 is the same as the grounding contact pad 63 in shape and thickness. The dummy pads 41 on the opposite ends of the substrate are not interconnected lengthwise along the substrate, although this is not shown in FIG. 1A.

Net-like conductive layers 50 and 60 are laid on the opposite (or upper and lower) surfaces of the substrate 30 to shield the signal lines 20 from the electromagnetic interference. Specifically, the net-like conductive layer 50 is laid on a second insulative substrate 70, which is laid on the upper surface of the first substrate 30. The second substrate 70 is as long and wide as the underlying first substrate 30, which has the signal line 20 longitudinally extending thereon. The second substrate 70 may have, as shown, its opposite ends notched to be in conformity with the signal contact pads 21, thus exposing them from the notches 71. As seen from the drawing, the grounding contact pads 53 are arranged in parallel with the notches 52 and 71. As used herein, the term “net” is intended to mean a random pattern of conductive traces laid so that the conductive traces cross each other as seen in the Figures. It is not intended to be a “grid”, in which the traces cross each other perpendicularly or a true “net” in which the strands also cross each other perpendicularly. Rather, both the conductive traces and the openings in this pattern are random,

The other net-like conductive layer 60 is laid directly on the lower surface of the flexible insulating substrate 30. As shown, the net-like conductor 60 also has lengthwise notches 62 and grounding contact pads 63 parallel-arranged at its conductor ends 61.

FIG. 2 shows one end of the FFC 10 comprising a lamination of the two flexible substrates 30 and 70 and the net-like conductor layers 50 and 60. The lamination is covered by a protective cover sheet 80 that encloses the upper and lower net-like conductive layers 50 and 60. As seen from the drawing, the signal contact pads 21 connecting to the signal lines 20 and the ground contact pads 53 connecting to the conductive layers 50 and 60 are arranged, preferably in parallel (wdiethwise), and are exposed from the protective cover sheet 80. On the other side (lower side) there are the dummy pads 41 and ground contact pads 63, which are also arranged in parallel (widthwise) in order to confront overlying signal contact pads 21 and ground contact pads 53 on opposite surfaces of the two substrates 30 and 70, respectively. As mentioned earlier, the signal contact pads 21 and ground contact pads 53 are respectively connected to the signal lines 20 and the net-like conductive layer 50.

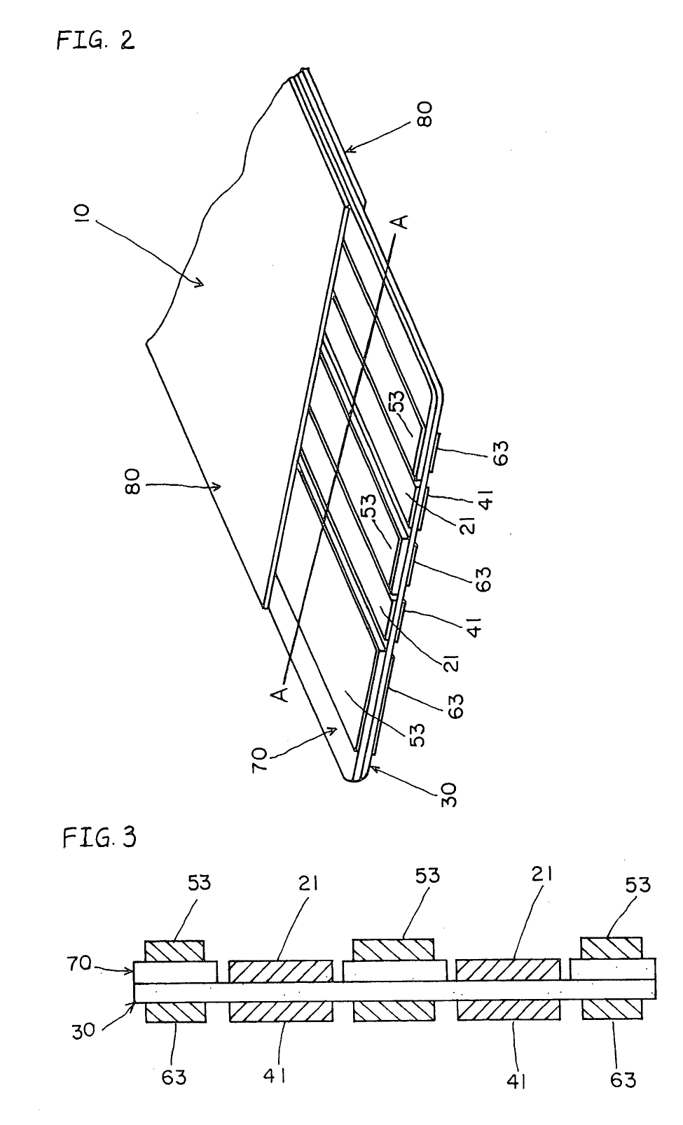

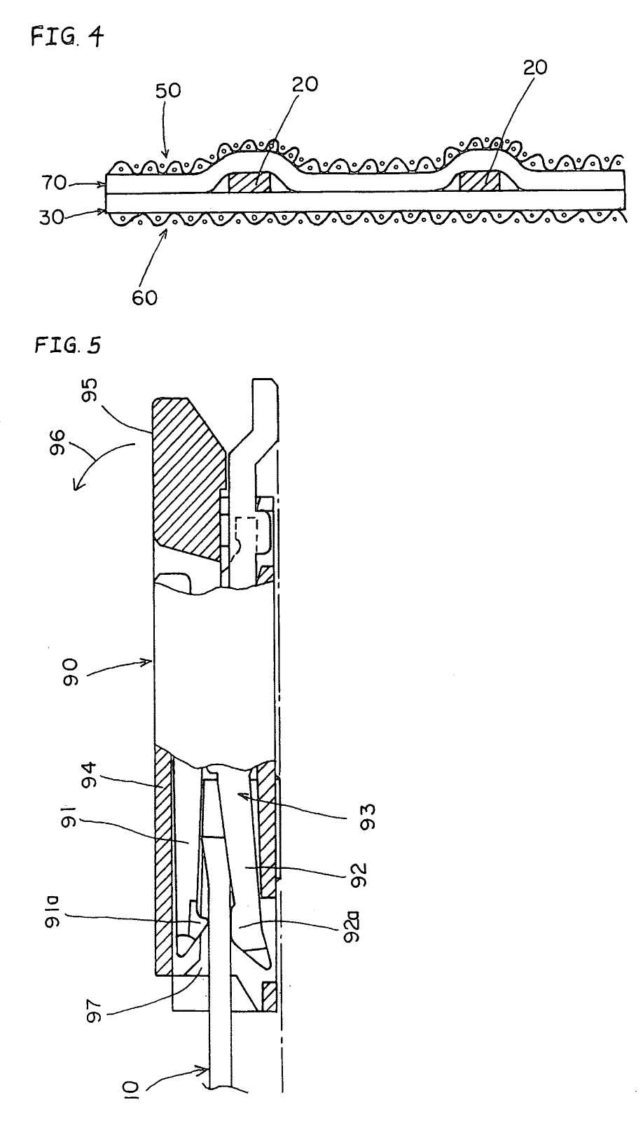

FIG. 3 is a cross section of the FFC 10 taken along line A-A of FIG. 2, and FIG. 4 is a cross section of the FFC 10 taken at the middle of the cable. These drawings roughly illustrate the structure, but do not represent the exact dimensional relationship (particularly thickness) of the cable. Thhe thickness is dependent on the thickness of the conductive layers and the substrates.

As seen in FIGS. 1B and 1C, the net-like conductive layers may be best described as random conductive traces or branches that are laid in no particular pattern so that they intersect with, or “cross” each other. These two Figures illustrate the spaces 56, 66 for each of the net-like conductive layers in an enlarged scale, and the crossing areas 55, 65 are determined in respect of locations on the basis of a table of random numbers. Thus, the spaces 56 and 66 are formed at random with respect to their shape and size. Thus, the spaces 56 of the upper net-like conductive layer 50 cannot be consistent with those 66 of the lower net-like conductive layer 60.

As for the characteristic impedance of the FFC 10, the crossing spots at which each signal line 20 crosses the irregular conductive branches 54 and 64 of the upper and lower net-like conductive layers 50 and 60 appear at random, and as a result the characteristic impedance of each signal line is averaged and equalized. The net-like conductive layer has an irregular pattern, allowing its branches 54 and 64 to extend in different directions. This irregularity provides a relatively large degree of freedom in designing signal lines 20 in shape and width so that the impedance of signal transmission lines utilizing this type of construction may be tuned to a desired level.

The fine adjustment to the characteristic impedance can be made in respect of the size and shape of each net-like conductor layer 50 or 60 and the thickness for each of the substrates 30 and 70. Thus, the degree of freedom in tuning the impedance of the FFC is significantly increased.

In place of the flexible substrates 30 and 70, non-flexible or rigid substrates can be used as in a conventional printed circuit board. The FFC 10 shown and described so far has only two signal lines formed thereon, but the number of signal lines can be one or three or more.

Now, a connection structure making an electric connection between an electric connector 90 and a FFC transmission line 10 of the present invention 10 is shown in FIG. 5. The connector 90 has a plurality of terminals 93 arranged in parallel in its insulating housing 94. Each terminal 93 has a bifurcate contact beam 91, 92. These terminals 93 are spaced apart from each other at same intervals as the ground contact pads 53 and signal contact pads 21. Also, the insulating housing 94 has an actuator 95 to open and close the upper and lower contact beams 91 and 92.

The actuator 95 can turn from the closed position to the open (releasing) position or vice-versa. When the actuator 95 is rotated in the direction as indicated by arrow 96, the gap between the upper and lower contact beams 91 and 92 is widened, thus allowing insertion of an end of an extent of FFC 10 from the cable inlet 97. When the actuator 95 is rotated in the opposite direction, the gap between the upper and lower contact beams 91 and 92 is reduced to grip the cable end.

When the actuator 95 is rotated toward the closed position, the gap between the upper and lower contact beams 91 and 92 is reduced to grip the FFC 10 by the end while the contact beams 91 and 92 are elastically yieldingly bent, or deformed. Thus, the contacts 91a of the upper contact beams 91 are pushed against the signal contact pads 21 and ground contact pads 53 on the upper surface of the flat, flexible cable 10 whereas the contacts 92a of the lower contact beams 92 are pushed against the dummy pads 41 and ground contact pads 63 on the lower surface of the FFC 10.

The dummy pads 41 and the grounding contact pads 63 on the other surface of the flexible substrate 30 are preferably flush with each other insofar as their overall height is concerned. This is down by making the contact pads the same thickness. Only for the sake of clarity, does FIG. 3 exaggeratedly shows the total thickness of the second substrate 70 and the grounding contact pad 53 as being taller than the thickness of the signal contact pad 21 on the one surface of substrate 30. These pads are typically made flush by using the signal contact pads 21 whose thickness is equal to the total thickness of the second substrate 70 and the ground contact pad 53. As long as the difference between the thickness of the signal contact pad 21 and the total thickness of the second substrate plus the ground contact pad can be absorbed by the bending of the upper and lower contact beams 91 and 92 of the terminals 93, all the contact pads can be regarded as being substantially flush along the ends of the FFC.

As a matter of fact, the terminals 93 can apply their contacts 91a and 92a to the signal contact pads 21, ground contact pads 53, 63, and dummy pads 41 at pressure large enough to establish reliable electric connections.

The upper and lower net-like conductive layers 50 and 60 on the opposite sides of the flexible substrate 30 can be electrically connected by the terminals 93, so that these net-like conductive layers 50 and 60 may be brought to a common or grounding potential. This makes it unnecessary to electrically connect the ground contact pads 53 and 63 on the opposite surfaces via plated through holes or conductor bumps as in another connection structure described below.

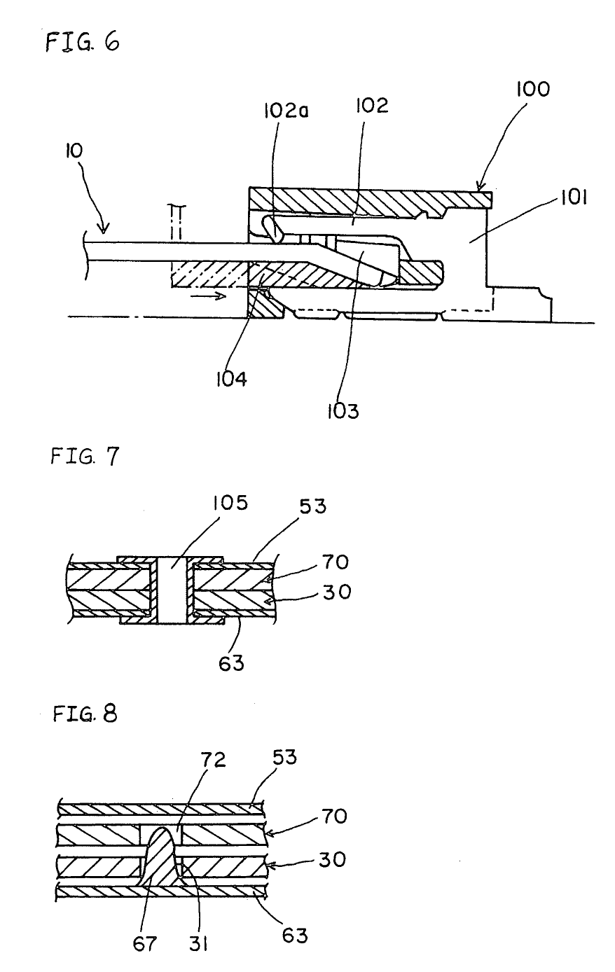

FIG. 6 shows a FFC connector constructed in accordance with another embodiment of the present invention. As shown, each terminal 101 has a single cantilever contact beam 102 extending into the cable cavity 103. After inserting a FFC 10 in the cable cavity 103, the actuator 104 is driven from the position (broken lines) in the cable cavity 103 to wedge the cable end as shown by solid lines. Then, the contact beams 102 of the terminals 101 are elastically bent while pushing their contacts 102a against the parallel signal contact pads 21 and the ground contact pads 53. These contact pads are flush, assuring that the contact beams 102 have their contacts 102a applied to the signal and ground contact pads 21 and 53 at equal pressure large enough to establish reliable electric connections.

In this connection structure the grounding contact pads 53 on one surface of the flat, flexible cable 10 cannot be electrically connected to those 63 on the other surface as is the case with the connection structure of FIG. 5. As shown in FIG. 7, therefore, the confronting grounding contact pads 53 and 63 are electrically connected by way of plated through-holes, or vias 105. Alternatively, the ground contact pads 63 of the net-like conductive layer 60 may have projections, or bumps 67 formed thereon and the first and second substrates 30, 70 may have apertures 31 and 72 formed therewith and in alignment with the bumps. Thus, when the three layers 60, 30 and 70 are laid on each other, the conductor bumps 67 are aligned with the apertures 31, 72 as shown in FIG. 8 and are pressed on each other, thereby making electrical connections between the upper and lower net-like conductive layers 50 & 60.

The dummy pads 41 remain in an electrically floating, or “isolated,” condition. If the floating condition is not desirable, these dummy pads 41 can be connected to the signal contact pads 21 by plated through holes 105 or conductor bumps 67 as is the case with the ground contact pads 53 and 63.

The present invention is described above as being applied to a flat, flexible cable, but it can be equally applied to a signal transmission board to provide the same advantage of assuring reliable electric connection. It will be apparent to those skilled in the art that changes and modifications may be made therein without departing from the spirit of the invention, the scope of which is defined by the appended claims.

1. A signal transmission line, comprising:
a first insulative substrate with first and second opposite surfaces, the first surface including at least one signal line extending between opposing end of the first substrate;
and two conductive layers, each of the two layers including a plurality of irregular openings disposed therein, the conductive layers being disposed on opposite surfaces of the first substrate, the openings being formed and arranged at randomly within each of said conductive layers.

2. The signal transmission line of claim 1, wherein said openings in each of said conductive layers are different in size.

3. The signal transmission line of claim 1, wherein said openings are different in shape.

4. The signal transmission line of claim 1, wherein the crossing areas for each of the net-like conductor layers are irregular.

5. The signal transmission line of claim 1, further including a second insulative substrate aligned with said first substrate, one of said two net-like conductive layers being disposed on the second substrate, and the other net-like conductive layer being disposed on the first substrate, said two net-like conductive layers being disposed on opposite sides of said signal transmission line.

6. The signal transmission line of claim 5, wherein each of the first and second substrates is formed of a flat, flexible material so that said signal transmission line is flat and flexible.

7. The signal transmission line of claim 5, wherein said one surface of said first substrate includes a signal contact pad and at least one ground contact pad arranged on each end of said first substrate, each signal contact pad being connected to the signal line, and each ground contact pad being connected to one of said net-like conductive layers, and the other surface of said first substrate including a dummy pad and at least one ground contact pad parallel arranged on each end of said first substrate, the dummy pad confronting the overlying signal contact pad via said first substrate, and each grounding contact pad being connected to the net-like conductor layer on the other surface of said first substrate, and confronting the overlying ground contact pad with said first and second substrates being interposed therebetween.

8. The signal transmission line of claim 7, wherein the ground contact pads on the one surface and the ground contact pads on the other surface of said first substrate are electrically connected together by conductor bumps.

9. The signal transmission line of claim 7, wherein the ground contact pads on the one surface and the ground contact pads on the other surface of said first substrate are electrically connected together by plated through-holes.

10. The signal transmission line of claim 7, wherein the signal contact pads on said one surface and said dummy pads on said other surface of said first substrate are electrically connected by conductor bumps.

11. The signal transmission line of claim 7, wherein the signal contact pads on said one surface and said dummy pads on said other surface of said first substrate are electrically connected by plated through-holes.

12. The signal transmission line of claim 7, wherein said signal contact pads and said ground contact pads are coplanar with each other on said one surface of said substrates.

13. The signal transmission line of claim 7, wherein said dummy pads and the ground contact pads are coplanar with each other on said other surface of the insulating substrate 30.
